(19) United States
(12) Patent Application Publication
(10) Pub. No.: US 2014/0241797 A1
(43) Pub. Date: Aug. 28, 2014

(54) SIMPLE ENGAGING DEVICE FOR MODULAR FURNITURE

(71) Applicant: YA YUN YANG, Taichung City (TW)

(72) Inventor: YA YUN YANG, Taichung City (TW)

(21) Appl. No.: 13/786,767

(22) Filed: Mar. 6, 2013

(30) Foreign Application Priority Data
Feb. 23, 2013 (TW) 102203481

(51) Int. Cl. F16B 12/44

(52) U.S. Cl. CPC F16B 12/44
USPC 403/403

(57) ABSTRACT

A simple engaging device for modular furniture includes a hinge-shaped base located at a joint of two flat pieces of the modular with a stationary plate member attached to one of the flat pieces, a screw nut attached to the other flat piece, and a set screw with a handle engaging with the nut through a locating bore of the movable plate member of the base; the stationary plate member is disposed with the first cylinder sections, and the movable plate member is disposed with the second cylinder sections; the first cylinder sections and the second cylinder sections are lined up axially and positioned alternately with a pin inserted and pivotally joined to the cylinder sections. The two flat pieces are assembled with an angle in between other than the right angle after the nut and the set screw engaging with each other.

### BACKGROUND OF THE INVENTION

1. Field of the Invention

The present invention relates to a simple engaging device for modular furniture, and more particularly to an engaging device capable of assembling two flat pieces of the modular furniture with an angle in between other than a right angle.

2. Description of Related Art

The modular furniture is usually set up by that flat pieces of the modular furniture, which are joined to each other, are attached with the conventional engaging devices with hand tools such as screw drivers, pliers, and hammers in advance; then, the flat pieces with the conventional engaging devices are assembled to each other. Because the conventional engaging devices are made of wood, plastics or metal, it is incapable of setting up the modular furniture without the hand tools. In addition, the appearance of the modular furniture looks always with parallel and perpendicular assembled flat pieces. Therefore, the currently available modular furniture has following disadvantages:

1. The flat pieces of the modular furniture are always assembled in parallel with right angles.

2. There are many different engaging devices needed to fix to the flat pieces such that it takes time to realize and classify the engaging devices to avoid mistaken assemblies.

3. The engaging devices are made of plastics, wood, and metal; the hand tools are needed to mount the engaging devices to the flat pieces and assemble the flat pieces; otherwise, the assembling job is incapable of being carried out successfully.

4. Most of the engaging devices are designed to be incapable of disengaging from the flat pieces; incorrect assembling may result in the modular furniture is not possible to be set up completely again.

5. To check so many parts with the parts drawings is a tedious work bothering the user because it is hard to distinguish the parts from the parts drawings.

### SUMMARY OF THE INVENTION

The main objective of the present invention is to provide a simple engaging device for modular furniture which has a hinge-shaped base and an embedded screw nut to ease the set-up job and to allow the flat pieces being assembled angularly and flexibly other than being parallel and right angles to improve deficiencies of the prior art.

### BRIEF DESCRIPTION OF THE DRAWINGS

Further benefits and advantages of the present invention will become apparent after a careful reading of the detailed description with appropriate reference to the accompanying drawings:

FIG. 1 is an exploded perspective view of an engaging device for modular furniture in accordance with the present invention;

FIG. 2 is a perspective view of the engaging device in accordance with the present invention.

### DETAILED DESCRIPTION OF THE INVENTION

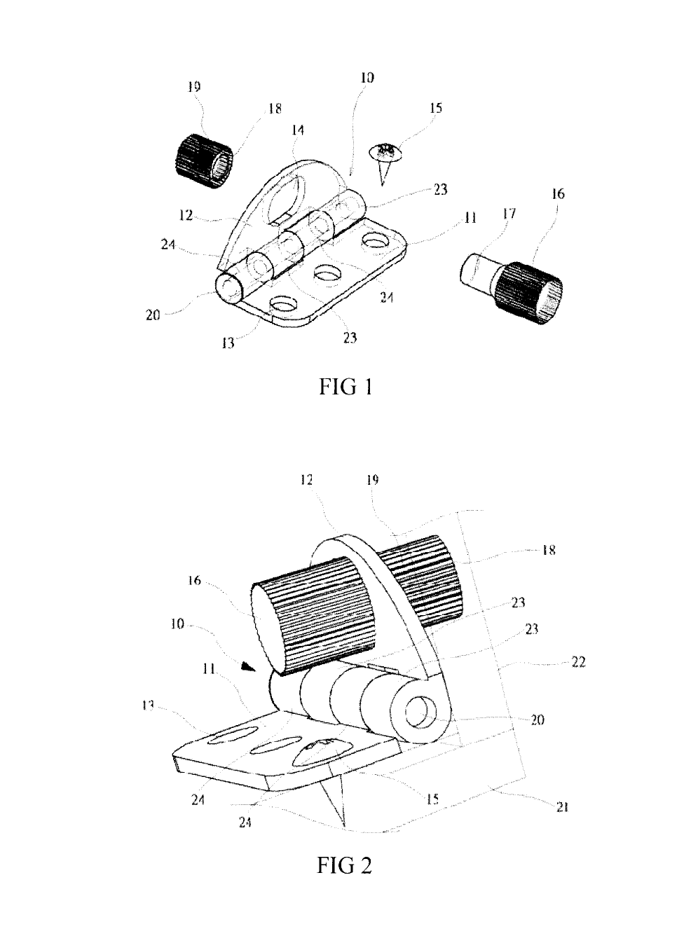

Referring to FIGS. 1 and 2, a preferred embodiment of an simple engaging device for modular furniture in accordance with the present invention basically has a hinge-shaped base 10 located at the joint of two flat pieces of the modular furniture and composed of a stationary plate member 11 and a movable plate member 12; there are two hollow cylinder sections 24 disposed at the side of the stationary plate member 11 next to the movable plate member 12, and the two cylinder sections 24 space apart from each other; there are two hollow cylinder sections 23 disposed at the side of the movable plate member 12 next to the stationary plate 11, and the two cylinder sections 23 space apart from each other and alternately lined up with the two cylinder sections 24; a pin 20 is inserted in and pivotally fixed to the cylinders 23, 24 to prevent the stationary plate member 11 and the movable plate member 12 separating from each other axially. The stationary plate member 11 is disposed with a set of fixing holes 13 and attached to a flat piece 21 with screws 15.

The movable plate member 12 of the base 10 is disposed with a locating bore 14. A screw nut 18 with an outer embossed circumferential side is attached to a flat piece 22 of the modular furniture corresponding to the locating bore 14. A set screw 17 has an embossed handle part 16 and engages with the screw nut 18.

The base 10 with the plate members 11, 12 is attached to the flat piece 21 in advance during the flat piece 21 being fabricated, and the screw nut 18 is attached to the flat piece 22 in advance as well during the flat piece 22 being fabricated. When the flat pieces 21, 22 are assembled together, the only thing has to be done by the user is to pass the set screw 17 through the locating bore 14 to engage with the screw nut 18 with the handle part 16 pressing against the movable plate member 12. Under the circumferences, the flat pieces 21, 22 are assembled together with an angle between the two flat pieces being other than a right angle to allow the furniture to present versatile styles.

Although the invention has been explained in relation to its preferred embodiment, it is to be understood that many other possible modifications and variations can be made without departing from the spirit and scope of the invention as hereinafter claimed.

What is claimed is:

1. A simple engaging device for modular furniture with flat pieces comprising:
a hinge-shaped base further comprising a stationary plate member being attached to one of the flat pieces, and a movable plate member with a locating bore being pivotally joined to the stationary plate member;
a screw nut with an embossed outer surface being attached to another one of the flat pieces;
a set screw corresponding to the screw nut, having a handle part, and engaging with the screw nut through the locating bore with the handle part pressing against the movable plate member;
wherein the stationary plate member has a side disposed with a plurality of first cylinder sections, and the movable plate member has a side next to the stationary plate disposed with a plurality second cylinder sections, and the first cylinder sections and the second cylinder sections are alternately positioned and lined up axially with a pin inserted and pivotally joined to the cylinder sections;
wherein the screw nut and the set screw engage with each other to assemble the two flat pieces together with an angle between the two flat pieces being other than a right angle.
